(19) United States
(12) Patent Application Publication
(10) Pub. No.: US 2026/0217122 A1
(43) Pub. Date: Jul. 30, 2026

(54) DISPLAY SYSTEM, CONTROL METHOD, AND COMPUTER PROGRAM

(71) Applicant: Sony Honda Mobility Inc., Tokyo (JP)

(72) Inventors: Rei Kato, Tokyo (JP); Hidehiro Komatsu, Tokyo (JP)

(73) Assignee: Sony Honda Mobility Inc., Tokyo (JP)

(21) Appl. No.: 19/142,439

(22) PCT Filed: Dec. 28, 2023
(86) PCT No.: PCT/JP2023/047331

§ 371 Date: Jun. 23, 2025

(30) Foreign Application Priority Data
Dec. 28, 2022 (JP) 2022-212464

(51) Int. Cl. B60K 35/81; B60K 35/22; B60K 35/29

(52) U.S. Cl. CPC B60K 35/81; B60K 35/22; B60K 35/29; B60K 2360/1526; B60K 2360/186; B60K 2360/195

(57) ABSTRACT

A display system includes a display device provided in a moving body, and a control device configured to display an image on the display device by dividing a display surface of the display device into a first display region and a second display region, and maintain the first display region when display content in the second display region is changed.

### TECHNICAL FIELD

The present invention relates to a display system, a control method, and a computer program.

Priority is claimed on Japanese Patent Application No. 2022-212464, filed Dec. 28, 2022, the content of which is incorporated herein by reference.

### BACKGROUND ART

In recent years, it has become possible to mount an image display device with a larger display area in a vehicle. For example, a technology has been proposed in which a display unit with a horizontally elongated display screen is provided and an overhead image of the vehicle is displayed to effectively utilize the area (refer to, for example, Patent Document 1).

### CITATION LIST

### Patent Document

Patent Document 1: Japanese Unexamined Patent Application, First Publication No. 2017-038349.

### SUMMARY OF INVENTION

### Technical Problem

However, in the past, it may not have been possible to sufficiently improve the convenience of an image display device with a large display screen. For example, it may not have been possible to sufficiently improve the convenience of an image display device that is configured so that a driver and other passengers can view it simultaneously. Such a problem is not limited to an image display device in a vehicle, and is also a problem that is present in an image display device in a general moving body.

An object of the present invention is to provide technology that can further improve the convenience of an image display device mounted on a moving body.

### Solution to Problem

(1) According to an aspect of the present invention, a display system includes a display device provided in a moving body; and a control device configured to display an image on the display device by dividing a display surface of the display device into a first display region and a second display region, and maintain the first display region in a case where display content in the second display region is changed.

(2) According to an aspect of the present invention, in the display system of the aspect of (1), the control device receives no input in the first display region, and receives an input in the second display region.

(3) According to an aspect of the present invention, in the display system of the aspect of (1), the control device controls an image display by setting an entire display surface of the display device as a third display region that is one display region, and the control device receives no input in a first region positioned on a driver side, and receives an input in a second region positioned on a passenger side, among the third display region.

(4) According to an aspect of the present invention, in the display system of the aspect of (3), in a case where the control device received an input instructing to change display content in the second region of the third display region, the control device sets the first region as the first display region, sets the second region as the second display region, and changes a display of the second display region.

(5) According to an aspect of the present invention, in the display system of the aspect of (1), the control device performs display in a different manner in a region of the display device that receives no input and a region of the display device that receives an input.

(6) According to an aspect of the present invention, in the display system of any one of the aspects of (1) to (5), the first display region is positioned on a driver side of the moving body in the display surface, and the second display region is positioned on a passenger side of the moving body in the display surface.

(7) According to an aspect of the present invention, in the display system of any one of the aspects of (1) to (5), the first display region displays driving information, for example, navigation information, external camera images, or the like.

(8) According to another aspect of the present invention, a control method includes displaying an image on a display device provided in a moving body by dividing a display surface of the display device into a first display region and a second display region, and maintaining the first display region in a case where display content in the second display region is changed.

(9) According to another aspect of the present invention, a computer program causes a computer to function as a control device that displays an image on a display device provided in a moving body by dividing a display surface of the display device into a first display region and a second display region, and maintains the first display region in a case where display content in the second display region is changed.

### Advantageous Effects of Invention

According to the aspects of (1) to (9) described above, it is possible to further enhance the convenience of the image display device mounted on the moving body.

### BRIEF DESCRIPTION OF DRAWINGS

FIG. 1 A schematic block diagram representing a system configuration of a display control system 100 according to an embodiment.

FIG. 2 A schematic block diagram representing an outline of a system configuration of a display system 20.

FIG. 3 A diagram representing an external appearance of a display device 22.

FIG. 4 A schematic block diagram representing an outline of a system configuration of an information providing device 80.

FIG. 5 A diagram representing a specific example of control of the display device 22.

FIG. 6 A diagram representing a specific example of the control of the display device 22.

FIG. 7 A diagram representing a specific example of the control of the display device 22.

FIG. 8 A diagram representing a specific example of the control of the display device 22.

FIG. 9 A diagram representing another specific example of transition shown in FIG. 8.

FIG. 10 A diagram representing a specific example of the control of the display device 22.

FIG. 11 A diagram representing a specific example of a display of the display device 22.

FIG. 12 A diagram representing a specific example of the display of the display device 22.

FIG. 13 A diagram representing a specific example of the display of the display device 22.

FIG. 14 A diagram representing a specific example of the display of the display device 22.

FIG. 15 A diagram representing a specific example of the display of the display device 22.

FIG. 16 A flowchart representing a specific example of a flow of processing in the display system 20.

FIG. 17 A diagram representing a modified example of the information providing device 80.

### DESCRIPTION OF EMBODIMENTS

Hereinafter, embodiments of a display system, a control method, and a computer program will be described in detail with reference to accompanying drawings. Note that the following embodiments do not limit the invention according to the claims, and not all combinations of features described in the embodiments are necessarily essential to the invention. Two or more features among a plurality of features described in the embodiments may be combined in any manner. In addition, the same reference numbers will be used for the same or similar configurations, and duplicated descriptions will be omitted.

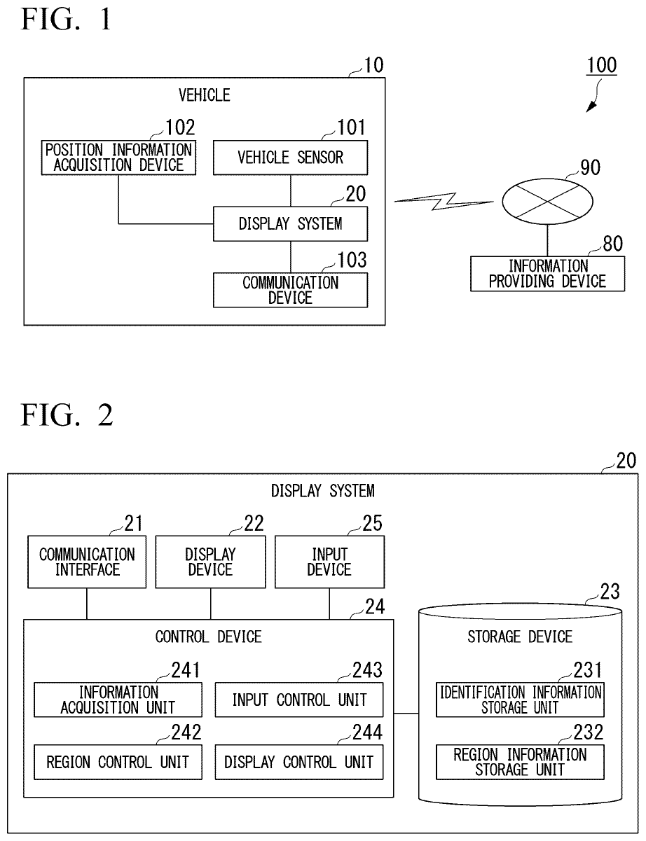

FIG. 1 is a schematic block diagram which shows a system configuration of a display control system 100 according to one embodiment. First, an outline of the display control system 100 will be described. The display control system 100 includes a moving body and an information providing device 80. The vehicle 10 shown in FIG. 1 is a specific example of a moving body. In the following description, the vehicle 10 will be used as a specific example of a moving body. Note that the moving body may be anything that a driver can ride in and can be moved by a power source. Examples of a moving body include an airplane, a robot (walking robot, flying robot, or the like), a train, or the like.

The vehicle 10 communicates with the information providing device 80 via a network 90. The vehicle 10 may be connected to the network 90, for example, via a base station. The network 90 may be a network using wireless communication or a network using wired communication. The network 90 may be configured by combining a plurality of networks.

The vehicle 10 is a moving body having a power source such as an automobile, an electric vehicle, or a hybrid vehicle. An automobile is a vehicle using an internal combustion engine such as a diesel engine or a gasoline engine as a power source. An electric vehicle is a vehicle using an electric motor as a power source. A hybrid vehicle is a vehicle that combines an internal combustion engine and an electric motor. In description of the present embodiment, a constituent for causing the vehicle 10 to travel is not shown or described. Specific examples of such an omitted constituent include, for example, a driving operator, a drive device such as an engine or a motor, a steering device, and a brake device. Any of these constituents may be mounted on the vehicle 10.

The vehicle 10 includes a vehicle sensor 101, a position information acquisition device 102, a communication device 103, and a display system 20.

The vehicle sensor 101 is a device that acquires information on the vehicle 10. Specific examples of the vehicle sensor 101 include a vehicle speed sensor, an acceleration sensor, a yaw rate sensor, an orientation sensor, and a gradient sensor. The vehicle speed sensor detects a speed of the vehicle 10. The acceleration sensor detects an acceleration of the vehicle 10. The yaw rate sensor detects an angular speed of the vehicle 10 around the vertical axis. The orientation sensor detects a forward direction of the vehicle 10. The gradient sensor detects a gradient of a point where the vehicle 10 is positioned. The vehicle sensor 101 outputs the acquired information to another device (for example, a display system 20) provided in the vehicle 10.

The position information acquisition device 102 acquires position information of a current position of the vehicle 10. The position information acquisition device 102 acquires position information of the current position, for example, by communicating with a satellite positioning system (GNSS: Global Navigation Satellite System) or a base station of a mobile phone network. Specific examples of the satellite positioning system include a global positioning system (GPS), a quasi-zenith satellite system (QZSS), Galileo, and the like. The position information acquisition device 102 outputs the acquired position information to another device (for example, the display system 20) provided in the vehicle 10.

The communication device 103 is a communication device that is communicatively connected to the network 90. The communication device 103 may be connected to the network 90 by wirelessly communicating with a base station device provided in the network 90. The communication device 103 may be connected to the network 90 by using, for example, 4G or 5G moving body communication technology. The communication device 103 may also be connected to the network 90 by communicating with a communication satellite. The communication device 103 communicates with other devices via the network 90. For example, the communication device 103 communicates with the information providing device 80. A device provided in the vehicle 10 (for example, the display system 20) can communicate with a device connected to the network 90 (for example, the information providing device 80) by using the communication device 103.

FIG. 2 is a schematic block diagram which shows an outline of a system configuration of the display system 20. The display system 20 includes a communication interface 21, a display device 22, a storage device 23, a control device 24, and an input device 25.

The communication interface 21 is a device that communicates with other devices. The communication interface 21 may be, for example, a cable interface that connects with other devices. The communication interface 21 may communicate with, for example, a vehicle sensor 101, a position information acquisition device 102, and a communication device 103 that are provided in the same vehicle 10.

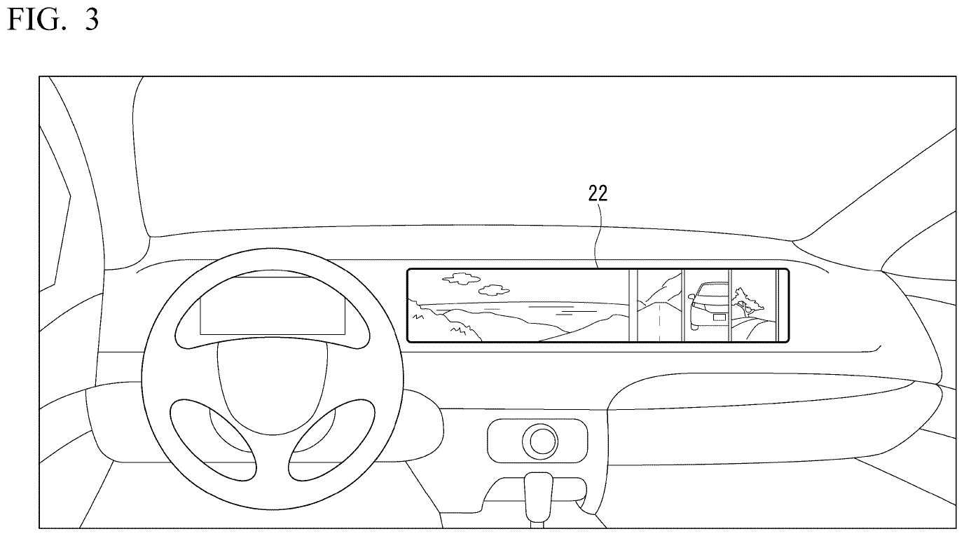

The display device 22 is a device configured by combining a device that displays an image with an input device that can input a position on the screen. The display device 22 is, for example, a touch panel. FIG. 3 is a diagram which shows an external appearance of the display device 22. The display device 22 is disposed at a position that is near a driver's seat of the vehicle 10 and at least visible to the driver. The display device 22 may be disposed at a position where it can be touched and seen by both the driver and a person sitting in the front passenger seat (hereinafter referred to as a “passenger”). The display device 22 may be configured as a device that projects an image into space and makes it appear to float. In this case, the display device 22 may be configured to receive an operation performed by a hand of a person in the space where the image is projected as an input.

Referring back to FIG. 2, the description will be continued. The storage device 23 is configured using a storage device such as a magnetic storage device or a semiconductor storage device. The storage device 23 functions as an identification information storage unit 231 and a region information storage unit 232. The identification information storage unit 231 stores identification information (hereinafter referred to as “system identification information”) that uniquely indicates the display system 20.

The region information storage unit 232 stores region information. The region information is information in which regions of the display device 22 are associated with control content in those regions. There may be a plurality of types of combinations of the regions of the display device 22 and their control content. Each type may be defined as a control mode. The control content may indicate, for example, a type of information to be displayed in a corresponding region, or may indicate a method of receiving an input in a corresponding region. The method of receiving an input may indicate, for example, whether to receive an input (operation) to a touch panel.

The control device 24 is configured using a processor such as a central processing unit (CPU) and a memory. The control device 24 functions as an information acquisition unit 241, a region control unit 242, an input control unit 243, and a display control unit 244 by the processor executing a program. All or part of functions of the control device 24 may be realized using hardware such as an application specific integrated circuit (ASIC), a programmable logic device (PLD), or a field programmable gate array (FPGA). The program may be recorded on a computer-readable recording medium. Examples of the computer-readable recording medium include, for example, a portable medium such as a flexible disk, a magneto-optical disc, a ROM, a CD-ROM, or a semiconductor storage device (for example, an SSD: Solid State Drive), and a storage device such as a hard disk or a semiconductor storage device embedded into a computer system. The program may be transmitted via an electric communication line.

The information acquisition unit 241 acquires information by receiving information from other devices. For example, the information acquisition unit 241 may acquire information from the vehicle sensor 101 via the communication interface 21, may acquire position information of the vehicle 10 from the position information acquisition device 102, or may acquire information from the information providing device 80 via the communication device 103. The information acquisition unit 241 may acquire information indicating content of an operation performed by an operator such as a driver or a passenger on the display device 22.

The region control unit 242 controls the display device 22 on the basis of the region information stored in the region information storage unit 232. The region control unit 242 controls a display on the display device 22 on the basis of, for example, the region information. The region control unit 242 controls reception of an input corresponding to an operation performed on the display device 22 on the basis of, for example, the region information.

The input control unit 243 receives inputs from the display device 22 and the input device 25. When an input from the display device 22 is received, the input control unit 243 receives the input in accordance with control by the region control unit 242. For example, in a region which is controlled by the region control unit 242 not to receive an input, the input control unit 243 does not receive the input even if an operation is performed by a user. For example, in a region which is controlled by the region control unit 242 to receive an input, the input control unit 243 receives the input in accordance with an operation by a user.

The display control unit 244 controls a display of an image on the display device 22 in accordance with the control by the region control unit 242. For example, when a region of a display screen is controlled by the region control unit 242, the image is displayed according to the region.

The input device 25 is configured using an input device other than a touch panel, such as a button, dials, a voice input device, or a controller. A user can perform an input to the display system 20 by performing an input to the input device 25.

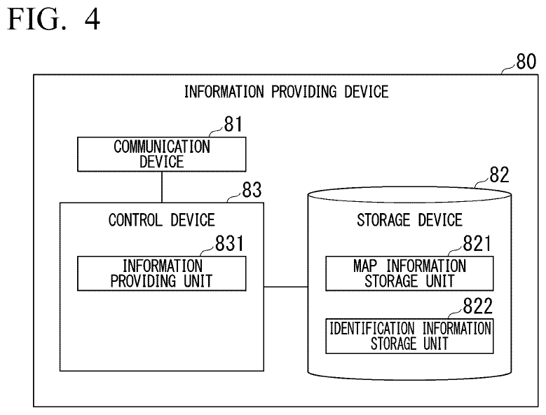

FIG. 4 is a schematic block diagram which shows an outline of a system configuration of the information providing device 80. The information providing device 80 includes a communication device 81, a storage device 82, and a control device 83.

The communication device 81 is a communication device that is communicatively connected to the network 90. The communication device 81 communicates with other devices via the network 90. For example, the communication device 81 communicates with the vehicle 10.

The storage device 82 is configured using a storage device such as a magnetic storage device or a semiconductor storage device. The storage device 82 functions as a map information storage unit 821 and an identification information storage unit 822. The map information storage unit 821 stores information on a map. The information on a map may store position information of a store or facility and information on the store or facility (information showing an outline, information showing details, and the like) in association with each other.

The identification information storage unit 822 stores system identification information and information on the display system 20 indicated by the system identification information in association with each other. The information on the display system 20 is, for example, information indicating a user of the display system 20 and information indicating attributes of the user of the display system 20 (information such as gender, age, preferences, search history in the past, and history of visited places in the past).

The control device 83 is configured using a processor such as a CPU and a memory. The control device 83 and the processor execute a program, thereby functioning as an information providing unit 831. All or part of functions of the control device 83 may be realized using hardware such as an ASIC, PLD, or FPGA. The program may be recorded on a computer-readable recording medium. Examples of the computer-readable recording medium include a portable medium such as a flexible disk, an optical magnetic disc, a ROM, a CD-ROM, or a semiconductor storage device (for example, an SSD), and a storage device such as a hard disk or a semiconductor storage device embedded into a computer system. The program may be transmitted via an electric communication line.

The information providing unit 831 provides information to the vehicle 10 by transmitting data via the network 90. The information provided by the information providing unit 831 is, for example, information stored in the map information storage unit 821. That is, the information providing unit 831 may provide map information, or information on a store or facility and its position information. The information provided by the information providing unit 831 does not have to be limited to these pieces of information.

The information providing unit 831 may provide common information to a plurality of vehicles 10, regardless of the users or the positions. The information providing unit 831 may provide the vehicle 10 with information selected according to, for example, the user of the vehicle 10. The information providing unit 831 may provide the vehicle 10 with information selected according to, for example, position information of the vehicle 10. The information providing unit 831 may provide the vehicle 10 with information selected according to, for example, the position information and the user of the vehicle 10. The information providing unit 831 may provide the vehicle 10 of a user with information selected by the user.

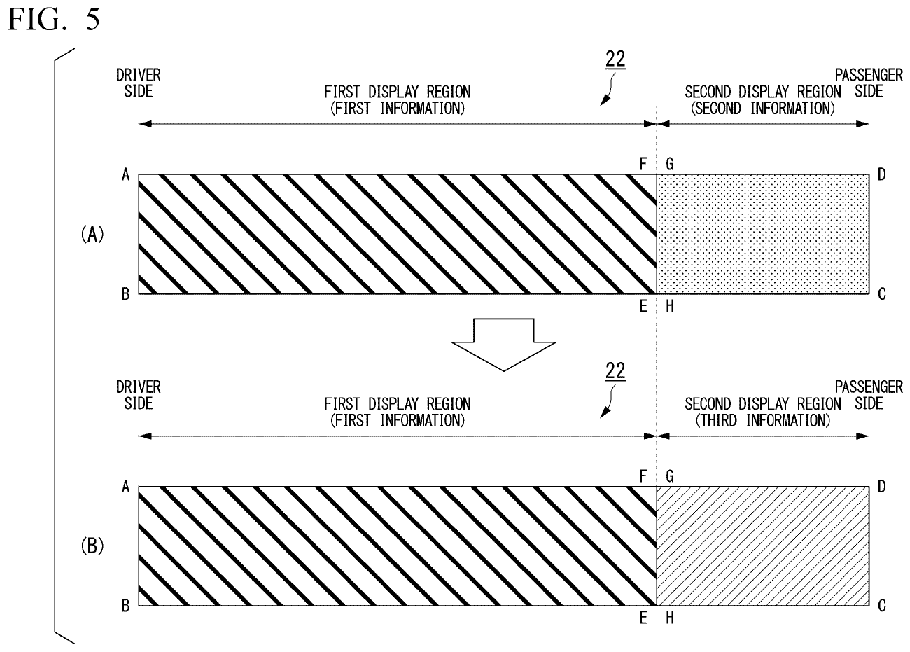

Specific examples of combinations of the regions of the display device 22 and their control content will be described below. FIG. 5 is a diagram which shows a specific example of control of the display device 22. A horizontally long rectangle ABCD displayed in FIG. 5 indicates an entire display screen of the display device 22.

FIG. 5(A) shows a first state. In the first state, the entire display screen of the display device 22 is controlled by being divided into at least two display regions. Specifically, a first display region relatively positioned on a driver side and a second display region relatively positioned on a passenger side are provided on the display screen of the display device 22. The first display region is a region indicated by a rectangle ABEF in FIG. 5(A), and the second display region is the region indicated by a rectangle GHCD in FIG. 5(A). In FIG. 5(A), there is no gap between the first display region and the second display region, but a gap (a region where no image is displayed) or another display region may be provided between the first display region and the second display region.

In FIG. 5(A), first information is displayed in the first display region, and second information is displayed in the second display region. The first information includes, for example, information that is likely to be used when the driver drives (hereinafter referred to as “driving information”). Specific examples of driving information include map information, navigation information, images captured by an outside-vehicle camera (hereinafter referred to as “outside-vehicle images”), information displayed to be superimposed on the outside-vehicle images, information related to traveling of the vehicle 10, and information acquired by one or a plurality of the vehicle sensors 101 of the vehicle 10. The second information is information different from the first information.

FIG. 5(B) shows the second state. In the second state, the first display region relatively positioned on the driver side and the second display region relatively positioned on the passenger side are also provided on the display screen of the display device 22. In the second state, the first information is displayed in the first display region, and third information is displayed in the second display region. The third information is information different from the first information and the second information.

In the first and second states, the display device 22 may be controlled so that the first display region does not receive an input (operation) and the second display region receives an input. Such control makes it possible to attenuate the driver's motivation to operate the display device 22 and reduce a likelihood of the driver causing an accident by operating the display device 22. In addition, by preventing the passenger from operating the first display region that the driver is looking at, an operation area of the passenger can be narrowed down to the passenger side. As a result, it is possible to prevent arms or hands of the passenger from blocking a field of view of the driver and interfering with driving. The control described above may be executed only when the vehicle 10 is traveling. In other words, when the vehicle 10 is stopped, an input may be received even in the first display region.

In FIG. 5, a state of the display screen of the display device 22 transitions from the first state to the second state. In this manner, the region control unit 242 maintains the first display region when the state transitions from the first state to the second state. In other words, the region control unit 242 does not change a position and a size of the first display region when the state transitions from the first state to the second state. For example, the region control unit 242 does not change a position of a boundary between the first display region and the second display region when the state transitions from the first state to the second state. The transition from the first state to the second state occurs when the information displayed in the second display region is changed from the second information to the third information.

Such a change may be made, for example, in response to an operation on the first display region or the second display region, or may be made at a predetermined timing regardless of an operation of a user. The predetermined timing may be, for example, a predetermined time, a timing at which information obtained from the vehicle sensor 101 has satisfied a predetermined condition (for example, the vehicle 10 departs, the vehicle 10 stops, a window is open, or the like), or a timing at which information obtained from the information providing device 80 is changed. That is, when the region control unit 242 is displaying the first and second display regions separately, the boundary between the first and second display regions is not changed when display content of the second display region is changed. Such control may be performed only when information displayed in the first display region is the driving information described above.

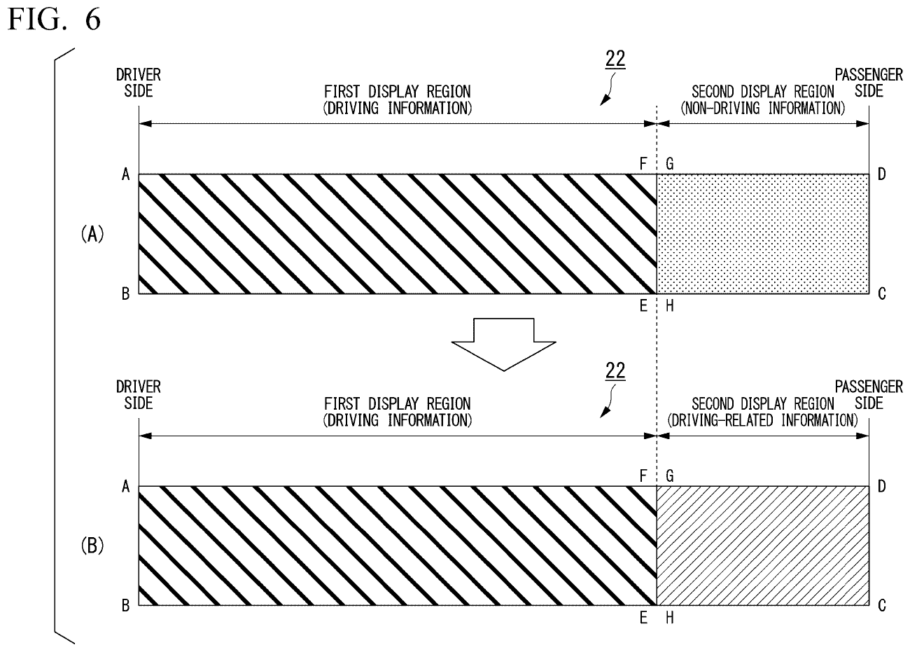

FIG. 6 is a diagram which shows a specific example of the control of the display device 22. FIG. 6 shows a more specific example of the control shown in FIG. 5. In FIG. 6, the horizontally long rectangle ABCD displayed indicates the entire display screen of the display device 22.

FIG. 6(A) shows the first state. Even in the first state shown in FIG. 6, the entire display screen of the display device 22 is controlled by being divided into at least two display regions (the first display region indicated by the rectangle ABEF and the second display region indicated by the rectangle GHCD). Also in FIG. 6(A), a gap or another display region may be provided between the first display region and the second display region.

In FIG. 6(A), driving information is displayed as a specific example of the first information in the first display region, and non-driving information is displayed as a specific example of the second information in the second display region. Non-driving information is information other than driving information. In other words, the non-driving information is information that is unlikely to be used when the driver is driving. Specific examples of the non-driving information include television images, information on television programs, images and music distributed over a network, information on these, weather information, e-mail information, SNS information, and the like. The non-driving information is not information on the vehicle 10 or information on surroundings or a vicinity of the vehicle 10.

FIG. 6(B) shows the second state. In the second state shown in FIG. 6, the first display region positioned relatively on the driver side and the second display region positioned relatively on the passenger side are also provided on the display screen of the display device 22. In the second state, the first display region displays driver information, and the second display region displays driving-related information. Unlike the driving information, the driving-related information is not information that is likely to be used when the driver is driving. However, the driving-related information is information related to the driving information. The driving-related information may be, for example, information related to past or current position information of the vehicle 10 or position information of a candidate to be reached in the future. Specific examples of such information may be information on a store or facility that the vehicle 10 has visited in the past, or information on a store or facility that is a candidate to be visited by the vehicle 10 in the future. Specific examples of such a store or facility include stores or facilities positioned within a predetermined range from the current position of the vehicle 10. Such a store or facility may be selected by the information providing device 80. The driving-related information may be information on a point of interest (POI). The information on the POI may also be selected by the information providing device 80.

The driving-related information may be provided from the information providing device 80.

In FIG. 6 as well, the display device 22 may be controlled so that in the first and second states, the first display region does not receive an input (operation) and the second display region receives an input. This control makes it possible to attenuate the driver's motivation to operate the display device 22 and reduce the likelihood of the driver causing an accident by operating the display device 22. The control described above may also be executed only when the vehicle 10 is traveling. In other words, even when the vehicle 10 is stopped, the first display region may receive an input.

In FIG. 6 as well, the state of the display screen of the display device 22 transitions from the first state to the second state. In this manner, the first display region is maintained when the state transitions from the first state to the second state, as in the example shown in FIG. 5.

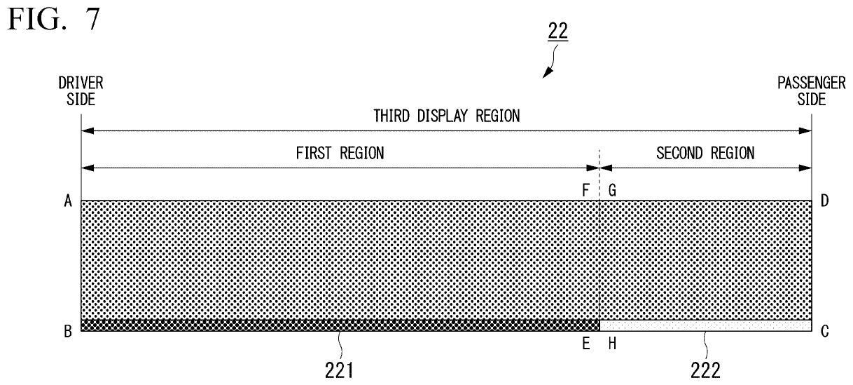

FIG. 7 is a diagram which shows a specific example of the control of the display device 22. FIG. 7 shows a third state. The horizontally long rectangle ABCD displayed in FIG. 7 indicates the entire display screen of the display device 22. In the third state, the rectangle ABCD, which is the entire screen of the display device 22, is controlled as one display region (a third display region). For this reason, for example, when a map image of a navigation function is displayed on the display device 22 in the third state, a continuous map image is displayed over the entire region of the rectangle ABCD.

On the other hand, in the third state, the region of the display device 22 (for example, the entire display screen) is controlled by being divided into at least two regions with respect to an input. Specifically, the display device 22 is provided with a first region relatively positioned on the driver side and a second region relatively positioned on the passenger side. The first region is a region indicated by the rectangle ABEF in FIG. 7, and the second region is a region indicated by the rectangle GHCD in FIG. 7. In FIG. 7, there is no gap between the first region and the second region, but a gap (a region in which input control differs from that of the first region and the second region) may be provided between the first region and the second region. In the third state, for example, driving information may also be displayed.

In the third state, the display device 22 is controlled so that the first region does not receive an input (operation) and the second region receives an input. Such control makes it possible to attenuate the driver's motivation to operate the display device 22, and reduce the likelihood of the driver causing an accident by operating the display device 22. The control described above may be executed only when the vehicle 10 is traveling. In other words, even when the vehicle 10 is stopped, the first display region may receive an input.

In the third state, information indicating the first region and the second region may be output. For example, different types of display may be performed in the first region and the second region. Such a display may be performed, for example, as a display in which a brightness or saturation of an image has changed, or an image showing a boundary (an image showing a line segment EF) may be displayed. In addition, images of different colors may be displayed in parts of the first and second regions. For example, an image extending from a left end to a right end of each region with a predetermined width may be displayed on upper or lower sides of the first and second regions. In the example of FIG. 7, an image 221 extending from a left end to a right end of the first region with a predetermined width is displayed along the lower side of the first region, and an image 222 extending from a left end to a right end of the second region with a predetermined width is displayed along the lower side of the second region.

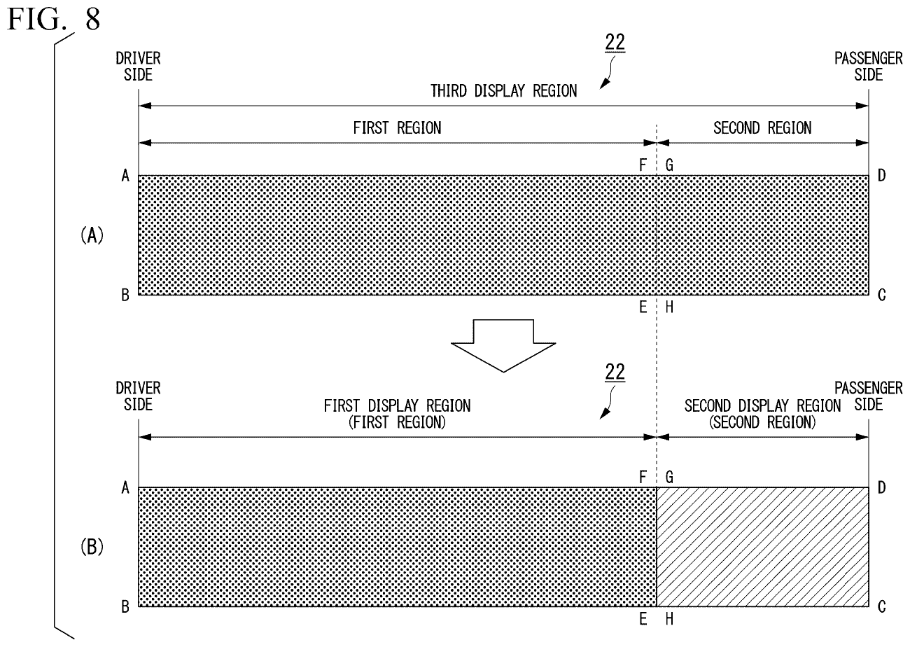

FIG. 8 is a diagram which shows a specific example of the control of the display device 22. FIG. 8(A) shows a specific example of the third state, and FIG. 8(B) shows the first state. In FIG. 8, the state of the display screen of the display device 22 is transitioning from the third state to the first state. In this manner, when the state transitions from the third state to the first state, the region control unit 242 sets the first region in the third state as the first display region in the first state. In other words, when the state transitions from the third state to the first state, the region control unit 242 sets a position of a boundary between the first region and the second region as a position of the boundary between the first display region and the second display region. The transition from the third state to the first state occurs when a part of the third display region on the passenger side (for example, the second region) displays information of a type different from the driving information (for example, non-driving information). Information displayed in the first display region in the first state after the transition from the third state may be a part or all of an image displayed in the third display region in the third state before the transition. For example, the image displayed in the first region in the third state may also be displayed in the first display region in the first state after the transition. For example, the image displayed in the third display region in the third state may be cut off approximately equally on both sides to fit the size of the first display region, and displayed in the first display region in the first state after the transition.

The display device 22 may be controlled so that the first display region after the transition does not receive an input (operation), and the second display region receives an input. The control described above may be executed only when the vehicle 10 is traveling. In other words, when the vehicle 10 is stopped, the first display region may also receive an input.

Such a change may be made in response to, for example, an operation on the second region, or may be made at a predetermined timing regardless of an operation of the user. The predetermined timing may be, for example, a predetermined time, a timing at which information obtained from the vehicle sensor 101 has satisfied a predetermined condition (for example, the vehicle 10 departs, the vehicle 10 stops, a window is open, or the like), or a timing at which information obtained from the information providing device 80 is changed. Such control may be performed only when the information displayed in the third display region is the driving information described above.

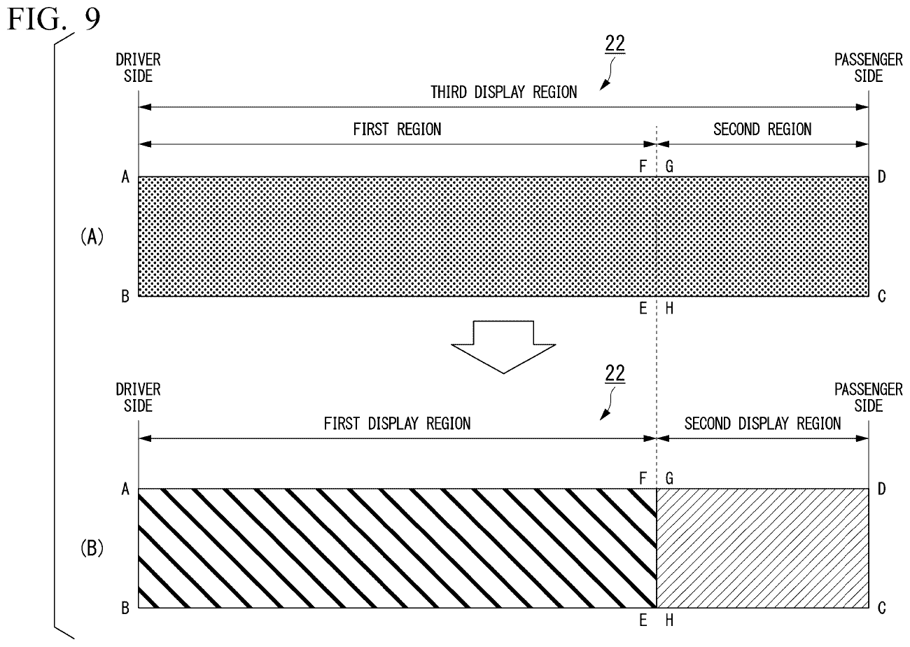

FIG. 9 shows another specific example of the transition shown in FIG. 8. FIG. 9(A) shows a specific example of the third state, and FIG. 9(B) shows the first state. In FIG. 8, a part or all of the image displayed in the third display region before the transition is displayed in the first display region after the transition, whereas in FIG. 9, an image different from the image displayed in the third display region is displayed in the first display region after the transition. FIG. 8 and FIG. 9 differ only in this respect, and other configurations and control are as described in FIG. 8. For this reason, other descriptions will be omitted in FIG. 9.

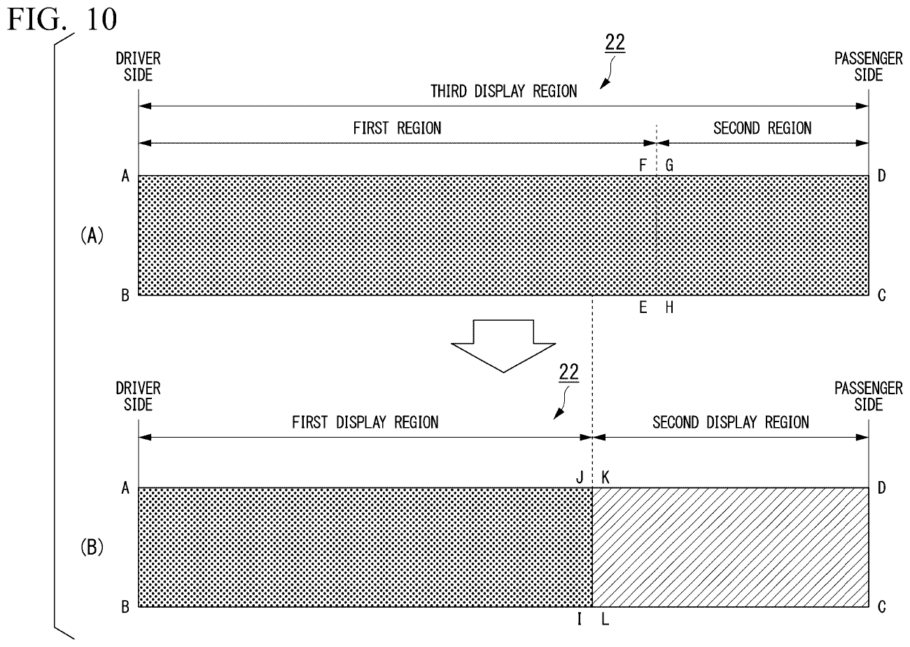

FIG. 10 is a diagram which shows a specific example of the control of the display device 22. FIG. 10(A) shows a specific example of the third state, and FIG. 10(B) shows the first state. In FIG. 10, the state of the display screen of the display device 22 transitions from the third state to the first state. At this time, unlike the specific examples shown in FIG. 8 and FIG. 9, in FIG. 10, the position and size of the first region before the transition are different from the position and size of the first display region after the transition. In this manner, when the state transitions from the third state to the first state, the region control unit 242 may set the first display region in the first state to a region different from the first region in the third state.

Such a transition from the third state to the first state occurs when a part of the third display region on the passenger side (for example, the second region) displays a type of information different from driving information (for example, non-driving information). The information displayed in the first display region in the first state after the transition from the third state may be a part or all of the image displayed in the third display region in the third state before the transition. For example, the image displayed in an area corresponding to the first display region in the third state may be displayed in the first display region in the first state after the transition. For example, the image displayed in the third display region in the third state may be cut off approximately equally on both sides to fit the size of the first display region and displayed in the first display region in the first state after the transition. The display device 22 may be controlled so that the first display region after the transition does not receive an input (operation) and the second display region receives an input. The control described above may be executed only when the vehicle 10 is traveling. In other words, when the vehicle 10 is stopped, the first display region may also receive an input.

Such a change may be made, for example, in response to an operation on the second region, or may be made at a predetermined timing regardless of the operation of the user. The predetermined timing may be, for example, a predetermined time, the timing at which information obtained from the vehicle sensor 101 has satisfied a predetermined condition (for example, the vehicle 10 departs, the vehicle 10 stops, a window is open, or the like), or the timing at which information obtained from the information providing device 80 is changed. Such control may be performed, for example, only when the information displayed in the third display region is the driving information described above.

In the description of FIGS. 8 to 10, the state before the transition was the third state, and the state after the transition was the first state. However, the state after the transition may be the second state. That is, when the state transitions from the third state to the second state, the control as described in any one of FIGS. 8 to 10 may be performed.

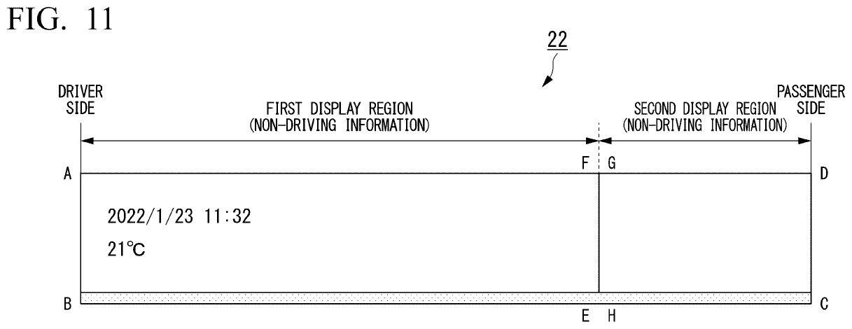

FIG. 11 is a diagram which shows a specific example of the display of the display device 22. The display as shown in FIG. 11 may be performed, for example, while the vehicle 10 is stopped. In the example of FIG. 11, the display device 22 is controlled by being divided into two display regions, the first display region and the second display region. Non-driving information is displayed in both the first display region and the second display region. For example, information indicating a date and time and information indicating a temperature are displayed in the first display region. Information indicating options of content to be displayed in the display device 22 is displayed in the second display region. In the display example of FIG. 11, the display device 22 is controlled so that both the first display region and the second display region receive an input. In this manner, the control to allow the first display region to receive an input may be performed, for example, on the basis of the vehicle 10 being stopped. The control to allow the first display region to receive an input may be performed, for example, on the basis of the vehicle 10 being stopped.

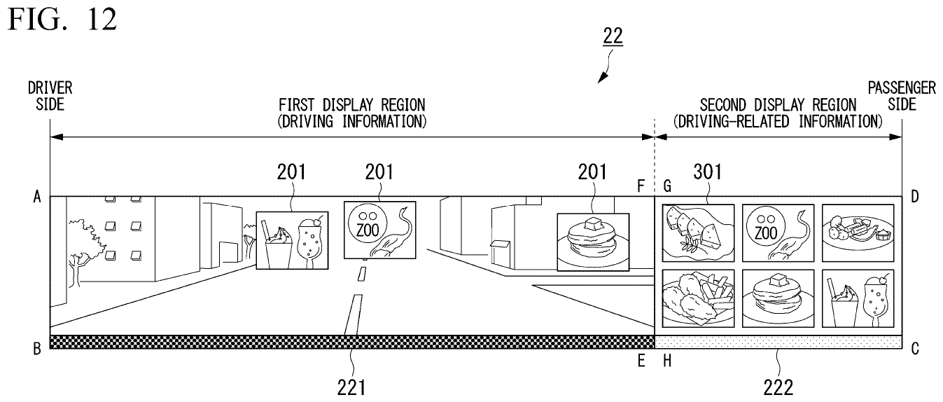

FIG. 12 is a diagram which shows a specific example of the display of the display device 22. The display device 22 in FIG. 12 is controlled as shown in FIG. 6(A). For this reason, as shown by the image 221 and the image 222, the display device 22 is controlled so that the first display region does not receive an input (operation) and the second display region receives an input. The display as shown in FIG. 12 is executed, for example, when an operation indicating that an outside-vehicle image is to be displayed is input.

The first display region displays an image showing a traveling direction of the vehicle 10 among the outside-vehicle images. In addition, the first display region displays a POI image 201 showing stores or facilities positioned within a predetermined range from the vehicle 10 to be superimposed thereon. The POI image 201 is disposed in accordance with a position of a store or facility in the outside-vehicle images. For example, a store B is positioned directly ahead of the vehicle 10 in a current traveling direction, and the POI image 201 indicating a position of the store B is displayed near a center of the first display region. The POI image 201 may include, for example, a part or all of information, such as an image, a name, route information, an estimated arrival time from a current time, and a distance from the current time, related to the store or facility.

The POI image 201 in FIG. 12 may be displayed with a high degree of transparency. That is, the POI image 201 related to a POI that has not been selected by the user (driver or passenger) may also be displayed with a high degree of transparency in the first display region. By being displayed in this manner, the POI image 201 that has not been selected by the user can be displayed without being an obstacle to the outside-of-vehicle images. That is, although there is a possibility that a plurality of unselected POI images 201 may be displayed, even if the plurality of images are displayed, their high transparency makes it unlikely to impede viewing of the outside-of-vehicle images.

In the second display region, a plurality of pieces of outline information 301 showing outline information of a POI are displayed as specific examples of driving-related information. The outline information 301 displayed in the second display region may be provided to the vehicle 10 from the information providing device 80. For example, in addition to a POI displayed in the first display region to be superimposed thereon, the outline information 301 of a POI that satisfies a predetermined condition may be displayed in the second display region. Specific examples of such POIs include stores and facilities that are positioned in a direction other than the traveling direction of the vehicle 10 (for example, rearward) and within a predetermined distance from the vehicle 10. The outline information 301 displayed in the second display region includes, for example, information on outlines of each store or facility. The outline information 301 may include, for example, a name, an attribute, and an image (for example, a thumbnail image).

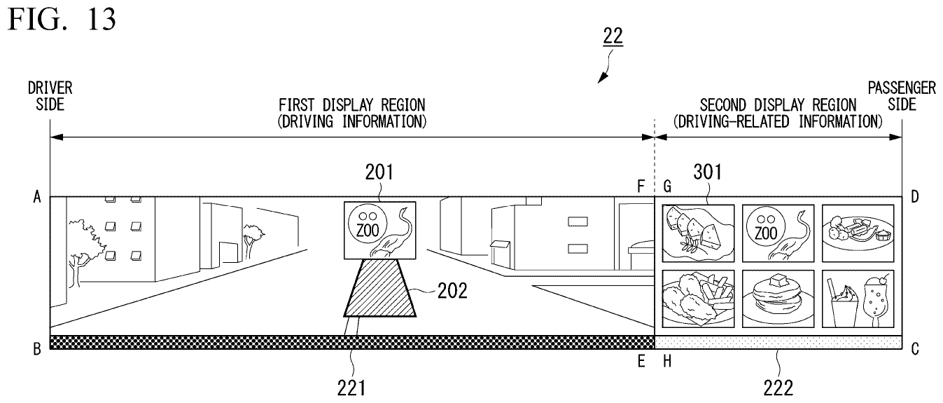

FIG. 13 is a diagram which shows a specific example of the display of the display device 22. The display device 22 in FIG. 13 is controlled as shown in FIG. 6(A). For this reason, as shown by the image 221 and the image 222, the display device 22 is controlled so that the first display region does not receive an input (operation) and the second display region receives an input. The display as shown in FIG. 13 is executed when one or the plurality of pieces of the outline information 301 shown as driving-related information are selected in the display as shown in FIG. 12. In the specific example of FIG. 13, the outline information 301 of the store B is selected.

The first display region displays an image showing the traveling direction of the vehicle 10 among the outside-vehicle images. In addition, the first display region displays the POI image 201 corresponding to the outline information 301 selected in the second display region to be superimposed thereon. Furthermore, the first display region displays a guidance image 202 showing a way to the store or facility indicated by the POI image 201. For example, the store B selected in the second display region is positioned directly ahead of the vehicle 10 in the current traveling direction, and the POI image 201 indicating the position of the store B and the guidance image 202 indicating the way to the store B are displayed near the center of the first display region.

The POI image 201 in FIG. 13 may be displayed with low or zero transparency. That is, the POI image 201 related to a POI selected by the user (driver or passenger) may be displayed in the first display region with a low degree of transparency or without transparency. By displaying in this manner, the POI image 201 selected by the user can be displayed in an easily visible manner.

A display in the second display region is the same as that in FIG. 12. By performing a display in this manner, the user can easily select outline information 301 (other outline information 301) different from the outline information 301 already selected (the store B in FIG. 13). When another piece of outline information 301 is selected, the POI image 201 already selected in the first display region may be hidden, and a POI image 201 corresponding to the newly selected piece of outline information 301 may be displayed. In addition, the display of the POI image 201 already selected in the first display region may be maintained as it is, while the POI image 201 corresponding to the newly selected piece of outline information 301 may be further controlled to be displayed.

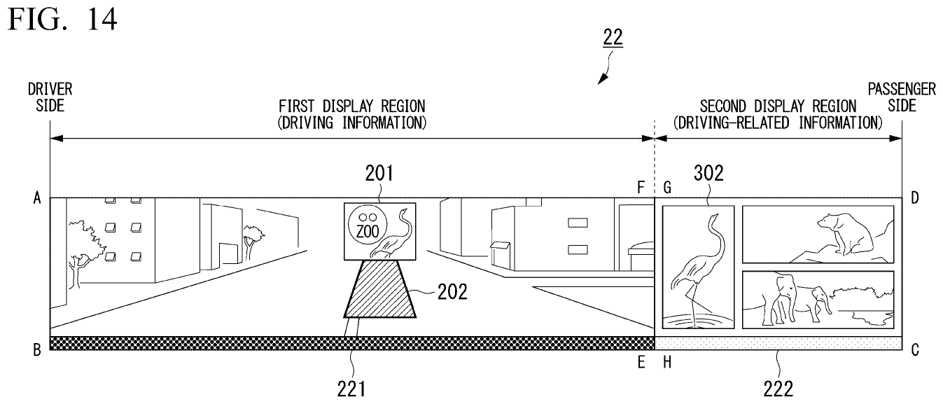

FIG. 14 is a diagram which shows a specific example of the display of the display device 22. In the display device 22 in FIG. 14, the control as shown in FIG. 6(A) is performed. For this reason, as shown in the image 221 and the image 222, the display device 22 is controlled so that the first display region does not receive an input (operation), and the second display region receives an input. The display as shown in FIG. 14 may be executed when one or the plurality of pieces of the outline information 301 shown as driving-related information is selected in the display as shown in FIG. 12. The display as shown in FIG. 14 may also be executed after a predetermined time (for example, 5 seconds, 10 seconds, or the like) has elapsed since the outline information 301 was selected in the display as shown in FIG. 13. In FIG. 13, the display of outline information 301 other than the outline information 301 of the store B already selected was maintained in the second display region, but in FIG. 14, detailed information 302 of the store B already selected is displayed. As described above, after one piece of outline information 301 is selected, possibility of selecting another piece of outline information 301 becomes low after a predetermined time has elapsed since the selection. Instead, more detailed information on the selected POI is more likely to be useful to the user. For this reason, by performing the display as in FIG. 14, it is possible to provide more useful information to the user. Note that information (including an image) included in the detailed information 302 may be provided from, for example, the information providing device 80.

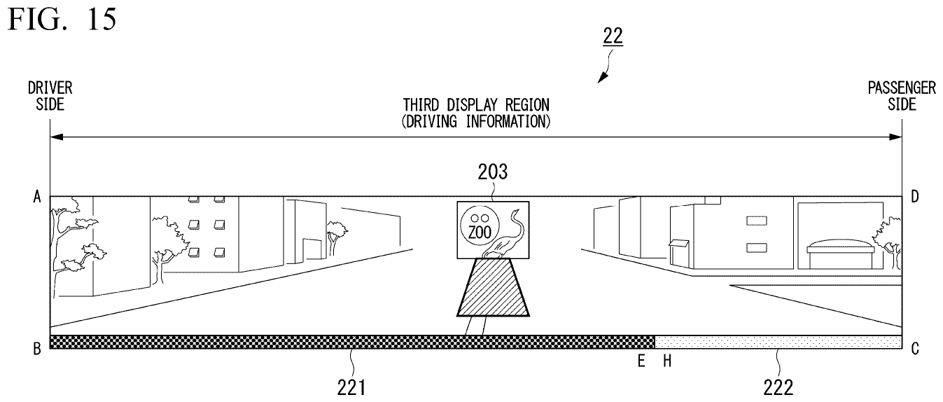

FIG. 15 is a diagram which shows a specific example of the display of the display device 22. In the display device 22 in FIG. 15, control is performed in the third state as shown in FIG. 7. For this reason, the rectangle ABCD, which is the entire screen of the display device 22, is controlled as one display region (the third display region). Furthermore, as shown in the image 221 and the image 222, the display device 22 is controlled so that the first region does not receive an input (operation) and the second region receives an input. The display as in FIG. 15 may be executed when an operation instructing a transition to the third state is input in the second display region when a POI is selected as in FIG. 13 or FIG. 14.

The first display region displays an image showing the traveling direction of the vehicle 10 among the outside-vehicle images. In FIG. 15, the outside-vehicle images are displayed in the third display region that is wider than the first display region in FIG. 13 and FIG. 14. For this reason, an image of a portion that is hidden (trimmed) in the first display region may also be displayed in the third display region.

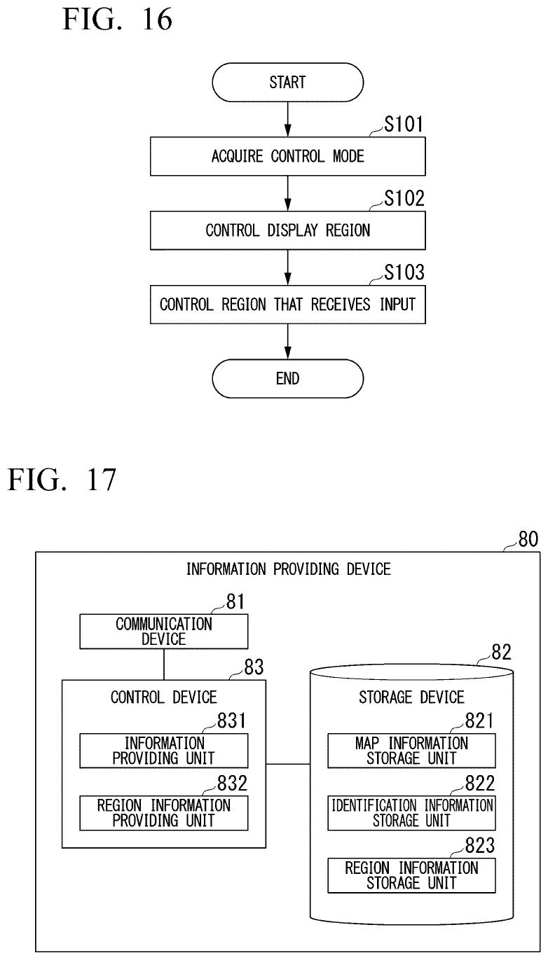

FIG. 16 is a flowchart which shows a specific example of a processing flow in the display system 20. The region control unit 242 acquires a current control mode of the display device 22 (step S101). Information indicating such a control mode may be stored, for example, in a memory of the control device 24. The region control unit 242 controls a display region according to the control mode (step S102). The region control unit 242 controls a region that receives an input according to the control mode (step S103).

The display control system 100 configured in this manner can further improve the convenience of the display device 22 provided in the vehicle 10. Specifically, this is as follows.

In the display control system 100, when a screen including the first display region and the second display region is displayed on the display device 22 provided in the vehicle 10, and the information displayed in the second display region is changed to different information, a display region of the first display region is maintained as it is. For this reason, it is possible to maintain high visibility for a person viewing display content of the first display region.

More specifically, when driving information is displayed in the first display region, the display region of the first display region may be maintained as it is when the information displayed in the second display region is changed to different information. In this case, it is possible to maintain high visibility of the driving information displayed in the first display region in particular, and further increase safety of driving the vehicle 10.

More specifically, when driving information is displayed in the first display region, and when the information displayed in the first display region is changed from non-driving information to driving-related information, the display region of the first display region may be maintained as it is. In this case, it is possible to maintain high visibility of the driving information displayed in the first display region, and to further improve convenience by improving a degree of freedom for passengers to change the information in the second display region.

In the display control system 100, when a screen including the first display region and the second display region is displayed on the display device 22 provided in the vehicle 10, an input is not received for operations performed in the first display region, but an input is received for operations performed in the second display region. For this reason, it is possible to attenuate the driver's motivation to operate the display device 22, and further improve the safety of driving the vehicle 10. Such control is performed when the vehicle 10 is traveling, and does not have to be performed when the vehicle 10 is stopped. That is, when the vehicle 10 is stopped, the control may be performed so that the first display region receives an input.

In the display control system 100, when an image is displayed on the entire screen of the display device 22 provided in the vehicle 10 as one display region (the third display region), an input is not received for operations performed in the first region, and an input is received for operations performed in the second region. For this reason, it is possible to attenuate the driver's motivation to operate the display device 22, and further improve the safety of driving the vehicle 10. Such control is performed when the vehicle 10 is traveling, and does not have to be performed when the vehicle 10 is stopped. That is, when the vehicle 10 is stopped, the control may be performed so that the first region may receive an input.

In the display control system 100, the entire screen of the display device 22 provided in the vehicle 10 is used as one display region (the third display region) to display an image, and when a state in which an input is not received for operations performed in the first region and an input is received for operations performed in the second region transitions to a display of an image using a plurality of display regions, the first region and the second region may be used as the first display region and the second display region, respectively. Even in this case, it is possible to attenuate the driver's motivation to operate the display device 22 and further increase the safety of driving the vehicle 10. Such control is performed when the vehicle 10 is traveling and does not have to be performed when the vehicle 10 is stopped. In other words, when the vehicle 10 is stopped, the control may be performed so that the first region also receives an input.

### Modified Example

The information providing device 80 does not necessarily have to be configured as a single device. For example, the information providing device 80 may be configured using a plurality of information processing devices. The plurality of information processing devices making up the information providing device 80 may be communicatively connected via a communication path such as a network 90, and configured as a system such as a cluster machine or a cloud.

FIG. 17 is a diagram which shows a modified example of the information providing device 80. The storage device 82 of the information providing device 80 may further function as a region information storage unit 823. The region information storage unit 823 stores information similar to the information stored in the region information storage unit 232, and a computer program for operating a computer as the region control unit 242. The control device 83 may further function as a region information providing unit 832. The region information providing unit 832 transmits the information (region information and a computer program) stored in the region information storage unit 823 to the display system 20. In this case, the display system 20 operates as the region control unit 242 by recording the received region information in the storage device 23 and executing the received computer program.

The above describes a form for carrying out the present invention using the embodiments, but the present invention is not limited to these embodiments, and various modifications and substitutions can be made within a range not departing from the gist of the present invention. A technical scope of the present invention also includes embodiments obtained by appropriately combining technical means disclosed in the different embodiments.

This can be applied to an image display device mounted on a moving body.

### Reference Signs List

100 Display control system
10 Vehicle
101 Vehicle sensor
102 Position information acquisition device
103 Communication device
20 Display system
21 Communication interface
22 Display device
23 Storage device
231 Identification information storage unit
232 Region information storage unit
24 Control device
241 Information acquisition unit
242 Region control unit
25 Input device
80 Information providing device
81 Communication device
82 Storage device
821 Map information storage unit
822 Identification information storage unit
83 Control device
831 Information providing unit
90 Network

1. A display system comprising:
a display device provided in a moving body; and
a control device configured to display an image on the display device by dividing a display surface of the display device into a first display region and a second display region, and maintain the first display region in a case where display content in the second display region is changed.

2. The display system according to claim 1,
wherein the control device receives no input in the first display region, and receives an input in the second display region.

3. The display system according to claim 1,
wherein the control device controls an image display by setting an entire display surface of the display device as a third display region that is one display region, and
the control device receives no input in a first region positioned on a driver side, and receives an input in a second region positioned on a passenger side, among the third display region.

4. The display system according to claim 3,
wherein, in a case where the control device received an input instructing to change display content in the second region of the third display region, the control device sets the first region as the first display region, sets the second region as the second display region, and changes a display of the second display region.

5. The display system according to claim 1,
wherein the control device performs display in a different manner in a region of the display device that receives no input and a region of the display device that receives an input.

6. The display system according to claim 1,
wherein the first display region is positioned on a driver side of the moving body in the display surface, and the second display region is positioned on a passenger side of the moving body in the display surface.

7. The display system according to claim 1,
wherein the first display region displays driving information.

8. A control method comprising:
displaying an image on a display device provided in a moving body by dividing a display surface of the display device into a first display region and a second display region; and
maintaining the first display region in a case where display content in the second display region is changed.

9. A non-transitory computer-readable storage medium storing a computer program for causing a computer to function as a control device that displays an image on a display device provided in a moving body by dividing a display surface of the display device into a first display region and a second display region, and maintains the first display region in a case where display content in the second display region is changed.
